(19) United States
(12) Patent Application Publication
(10) Pub. No.: US 2013/0038082 A1
(43) Pub. Date: Feb. 14, 2013

(54) VEHICLE SEAT EXTENDER

(71) Applicant: Marcelo Bertocchi, Indaiatuba (BR)

(72) Inventor: Marcelo Bertocchi, Indaiatuba (BR)

(73) Assignee: GM GLOBAL TECHNOLOGY OPERATIONS LLC, Detroit, MI (US)

(21) Appl. No.: 13/204,756

(22) Filed: Aug. 8, 2011

(51) Int. Cl. B60N 2/02; B23P 17/00

(52) U.S. Cl. 296/65.03; 29/401.1; 296/65.05

(57) ABSTRACT

A vehicle includes a vehicle body including a rear wall of a passenger compartment, a first member being mounted with respect to the wall, having a first surface that is generally horizontal, and defining a lower seat portion of a vehicle seat, and a second member having a second surface. The second member is selectively mountable to the rear wall such that the second surface is generally vertical and functions as a seatback. The second member is also selectively mountable to the first member such that the second surface is generally horizontal and cooperates with the first surface to provide a larger support for a child seat than just the first surface alone.

### TECHNICAL FIELD

This invention relates to seats for vehicle occupants.

### BACKGROUND

Vehicle seats typically include a lower seat portion and a seatback portion. The lower seat portion has a generally horizontal surface for supporting an occupant, and the seatback portion has a generally vertical surface for supporting the back of an occupant. In some vehicles, such as extended-cab pickup trucks, the fore/aft dimension of the lower seat portion is limited by the size of the passenger compartment or other considerations.

### SUMMARY

A vehicle includes a vehicle body having a wall that at least partially defines a vehicle passenger compartment; a first member being mounted with respect to the wall, having a first surface that is generally horizontal, and defining a lower seat portion of a vehicle seat; and a second member having a second surface. At least one fastening element is mounted with respect to the second member.

A first complementary fastening element is mounted with respect to the first member and is selectively engageable with the at least one fastening element to operatively connect the second member to the first member such that the second surface is generally horizontal. A second complementary fastening element is mounted with respect to the wall and is selectively engageable with the at least one fastening element to operatively connect the second member to the wall such that the second surface is generally vertical.

Accordingly, the second member may function as a seatback (or a portion thereof, such as a head rest) for a seat assembly (when connected to the wall) or as an extension to the first member to provide additional fore/aft support to a child seat.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, perspective view of a set of jump seats in a stowed configuration in a pickup truck;

FIG. 2 is a schematic, side view of one of the jump seats of FIG. 1 in the stowed configuration;

FIG. 3 is a schematic, perspective view of the jump seats of FIG. 1 in a deployed configuration;

FIG. 4 is a schematic, side view of one of the jump seats of FIG. 3 in the deployed configuration;

FIG. 5 is a schematic, perspective view of the jump seats of FIG. 1 in an extended configuration;

FIG. 6 is a schematic, side view of one of the jump seats of FIG. 5 in the extended configuration;

FIG. 7 is a schematic, perspective view of the lower seat portion of one of the jump seats of FIG. 1;

FIG. 8 is another schematic, perspective view of the lower seat portion of FIG. 7;

FIG. 9 is a schematic, perspective view of an extension member for use with the lower seat portion of FIGS. 7 and 8; and

FIG. 10 is a schematic, cross-sectional side view of the extension member attached to the rear wall of the pickup truck.

### DETAILED DESCRIPTION

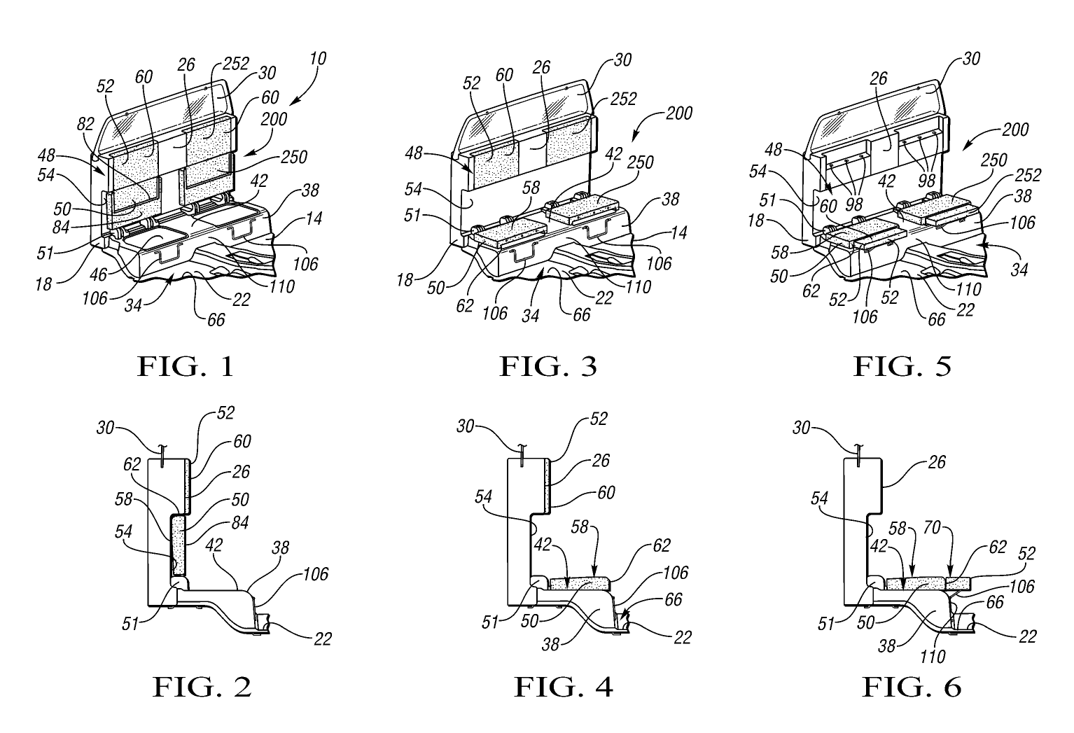

Referring to FIG. 1, a vehicle 10 includes a vehicle body 14, only a portion of which is shown in FIG. 1. The vehicle body 14 in the embodiment depicted has a pickup truck configuration, which includes a cab portion 18. The cab portion 18 includes a floor 22, a rear wall 26, and a rear window 30. The floor 22, rear wall 26, and window 30 cooperate with other body components to define a passenger compartment 34.

The body 14 includes structure 38 that defines a generally horizontal (i.e., more horizontal than vertical) surface 42 that is higher than the floor 22. In the embodiment depicted, the surface 42 is horizontal and defines a concavity 46. The passenger compartment 34 contains a plurality of vehicle seats for supporting vehicle occupants. The vehicle 10 includes front seats (not shown), including a driver seat and a front passenger seat. The vehicle 10 includes a rear seat assembly 48 disposed rearward of the front seats. The seat assembly 48 is movable between a stowed configuration, as shown in FIGS. 1 and 2, a deployed configuration, as shown in FIGS. 3 and 4, and an extended configuration, as shown in FIGS. 5 and 6.

The rear seat assembly 48 includes a first member 50 that is movably mounted with respect to the rear wall 26 and the structure 38 such that the seat assembly 48 is a foldable jump seat. More specifically, the first member 50 in the embodiment depicted is selectively rotatable with respect to the rear wall 26 between a stowed position, as shown in FIGS. 1 and 2, and a deployed position, as shown in FIGS. 3 and 4. More specifically, the first member 50 is mounted with respect to the wall 26 via hinges 51. The seat assembly 48 also includes a second member 52.

Referring specifically to FIGS. 1 and 2, when the seat assembly 48 is in the stowed configuration, the first member 50 is in its stowed position relative to the rear wall 26 and the structure 38. In the stowed position, the first member 50 is generally vertical, i.e., more vertical than horizontal, and is generally parallel with the rear wall 26. In the embodiment depicted, the first member 50 is at least partially disposed within a concavity 54 formed by the rear wall 26. The first member 50 has a seating surface 58 that is generally vertical and that abuts the rear wall 26 in the stowed configuration. The second member 52 is mounted in a first position with respect to the rear wall 26 above the first member 50. The second member 52 is selectively removable from the first position. The stowed configuration of the seat assembly 48 is intended for cargo transportation in the rear of the passenger compartment 34.

Referring to FIGS. 3 and 4, when the seat assembly 48 is in the deployed configuration, the first member 50 is in the deployed position. In the deployed position, the first member 50 is rotated approximately ninety degrees from its stowed position such that the first member 50 is generally horizontal. In the embodiment depicted, the first member 50 is supported by the surface 42 inside concavity 46, and the seating surface 58 is generally horizontal and upwardly facing to support a human occupant. Accordingly, the first member 50 functions as a lower seat portion. The second member 52, in its first position, is positioned to function as a seatback portion of the seat assembly 48. More specifically, the second member 52 includes a surface 60 that is generally vertical when the second member 52 is in the first position for supporting the back of the occupant. The structure 38 and the floor 22 cooperate to define a footwell 66 for the occupant's feet.

Referring to FIGS. 5 and 6, when the seat assembly 48 is in the extended configuration, the first member 50 is in its deployed position, and the second member 52 is removed from the first position and moved to a second position. In the second position, the second member 52 is mounted to the forward end 62 of the first member 50, thereby extending the effective fore/aft dimension of the lower seat portion of the seat assembly 48. More specifically, the second member 52 extends over a portion of the footwell 66. In the embodiment depicted, the surface 60 of the second member 52 faces downward. The second member 52 includes another surface 70, which faces upward when the second member 52 is in the second position. The surface 70 is adjacent to, and/or abuts, the seating surface 58. The surface 70 is also generally horizontal, and thus surfaces 58 and 70 cooperate to provide an extended support surface for a child seat (not shown).

Accordingly, the seat assembly 48 is converted from the deployed configuration, in which an adult may occupy the seat assembly 48, to the extended configuration, for supporting a child seat, by detaching or otherwise removing at least a portion of the seatback portion (i.e., the second member 52) from the wall 26 and attaching it to the lower seat portion (i.e., the first member 50). It should be noted that, although the second member 52 forms the entire seatback portion of the seat assembly 48 in the embodiment depicted, the second member may, within the scope of the claimed invention, form only a portion of the seatback portion. For example, and within the scope of the claimed invention, the second member 52 may function as a head rest, and another member (not shown) would form the remainder of the seatback portion.

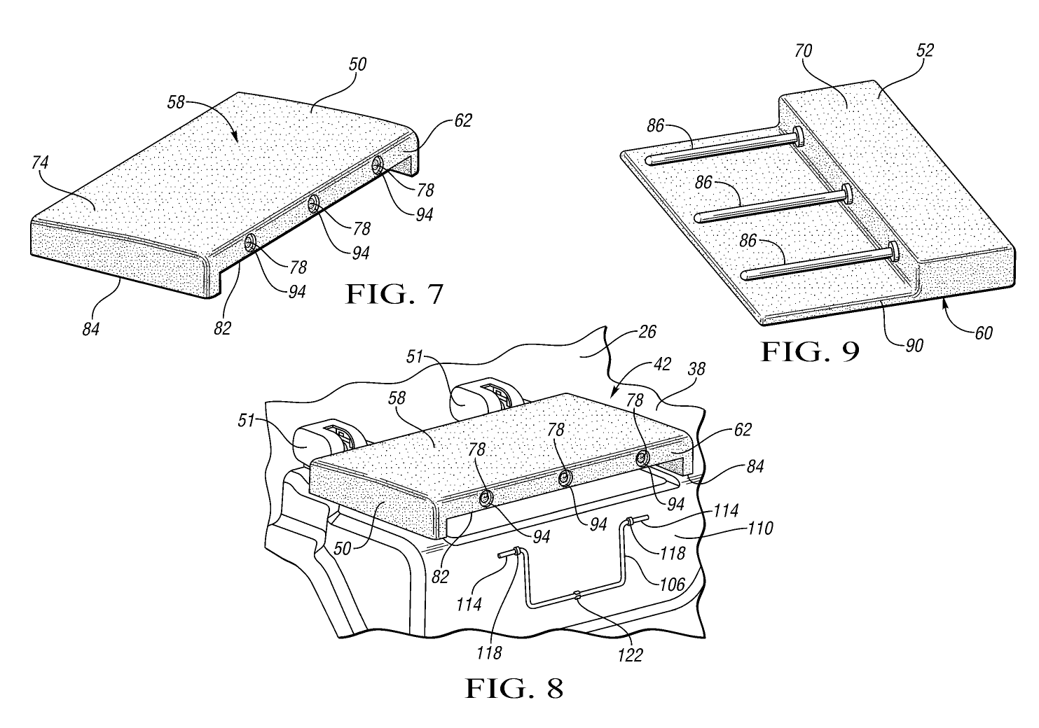

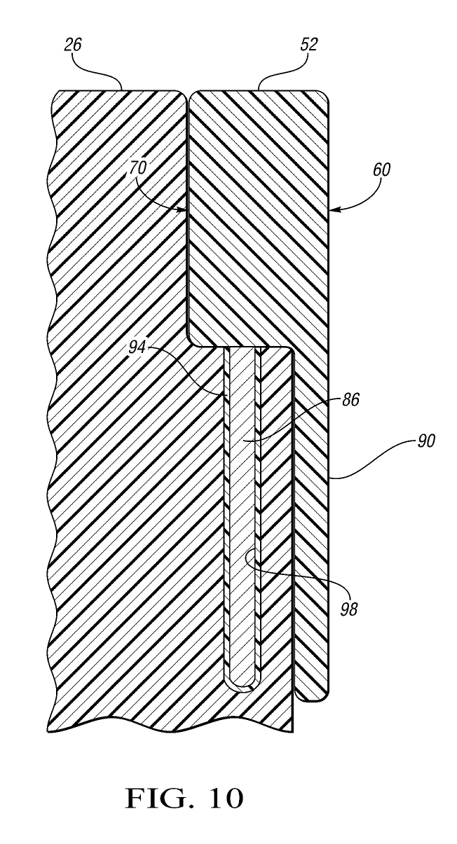

Referring to FIGS. 7 and 8, the first member 50 includes a cover 74 that defines the seating surface 58. The cover 74 may be formed by a flexible material such as fabric, leather, or vinyl. The first member 50 may include a frame (not shown) and cushioning material (not shown) inside the cover 74. The first member 50 also defines a plurality of concavities 78, 82 at the forward end 62 for receiving corresponding protrusions (shown at 86, 90 in FIG. 9) on the second member 52.

More specifically, in the embodiment depicted, the first member 50 includes three cylindrical holes 78 that are open at the forward end 62. The holes 78 are defined by plastic sleeves 94 that extend inside the cover 74. The first member 50 also defines a concavity 82 that is open at the forward end 62. The first member includes a surface 84 opposite the seating surface 58. The surface 84 and the forward end 62 cooperate to define the concavity 82.

Referring to FIG. 9, the second member 52 includes three cylindrical protrusions 86 that are positioned such that each of the protrusions 86 is disposed within a respective one of the holes 78 when the second member 52 is in its second position, thereby to secure the second member 52 to the first member 50. The sleeves 94 may include locking systems (not shown) to releasably retain the protrusions inside the holes 78. In the embodiment depicted, the protrusions 86 are steel, aluminum, or plastic rods.

In the embodiment depicted, the second member 52 is sufficiently long to form the entire seatback portion of the rear seat assembly 48. However, the full length of the second member 52 is not required (and may not be desirable) to be used to extend the effective fore/aft dimension of the lower seat portion 50. Accordingly, the concavity 82 accommodates a portion of the second member 52. More specifically, a portion of the second member 52 defines a rectangular protrusion 90 that extends inside the concavity 82 (between surface 84 of the first member 50 and surface 42 of the structure 38) when the second member 52 is in its second position.

Referring to FIGS. 5 and 10, the rear wall 26 defines three cylindrical holes 98. The holes 98 are upwardly open in order to receive a respective one of the protrusions 86 when the second member 52 is in the first position, thereby securing the second member 52 to the wall 26. The holes 98 may be formed by plastic sleeves 94.

Accordingly, the second member 52 includes at least one fastening element, namely protrusions 86. The first member 50 includes a first complementary fastening element that is engageable with the fastening element, namely concavities or holes 78. The wall 26 has a second complementary fastening element that is engageable with the fastening element, namely concavities or holes 98. It should be noted that other fastening elements and complementary fastening elements, such as latches, clips, etc., may be employed within the scope of the claimed invention instead of the protrusions 86 and concavities 78, 98. In the embodiment depicted, all of the fastening elements of the second member 52, i.e., protrusions 86, engage with the complementary fastening elements 78, 98 on the first member 50 and the wall 26. However, it should also be noted that, in an alternative embodiment (not shown) and within the scope of the claimed invention, the second member 52 may include a first fastening element that is engageable with the first complementary fastening element but not the second complementary fastening element, and a second fastening element that is engageable with the second complementary fastening element but not the first complementary fastening element.

Referring again to FIG. 8, a support member 106 is rotatably mounted to the front surface 110 of the structure 38. The support member 106 in the embodiment depicted is generally C-shaped, and is pivotably connected at each end 114 to the surface 110 via brackets 118. The support member 106 is selectively rotatable between a stowed position, as shown in FIGS. 1-4 and 8, and a deployed position, as shown in FIGS. 5 and 6. In the stowed position, a clip 122 releasably secures the support member 106 against the surface 110. In the deployed position, the support member 106 contacts, and is clipped to, the bottom of the second member 52 to further support the second member 52 in its second position.

In one embodiment, the second member 52 comprises an injected piece of foam with a wired structure inside. It should be noted that, within the scope of the claimed invention, the wall 26 may have single-piece construction or may include multiple pieces operatively connected to one another to define the wall 26. Furthermore, although the rear seat assembly 48 is a foldable jump seat, other seat assemblies may be employed within the scope of the invention. For example, a seat assembly may include a first member 50 that is substantially rigidly connected with respect to the wall 26, rather than being rotatable.

In the embodiment depicted, the vehicle body 14 includes two rear seat assemblies 48, 200. Seat assembly 200 is substantially identical to seat assembly 48, but is located on a different side of the passenger compartment 34 from seat assembly 48. More specifically, seat assembly 200 includes a lower seat portion member 250 that is substantially identical to the first member 50 and that is rotatably mounted with respect to the rear wall 26 and the structure 38 to function in a manner identical to that of the first member. Seat assembly 200 also includes a seatback member 252 that is substantially identical to the second member 52. The wall defines holes 98 above lower seat portion member 250 at which the seatback member 252 is mountable; accordingly, the seatback member 252 functions in an identical manner as the second member 52 to alternatively form a seatback portion for seat assembly 200 or to extend the fore/aft dimension of the lower seat portion 250.

While the best modes for carrying out the invention have been described in detail, those familiar with the art to which this invention relates will recognize various alternative designs and embodiments for practicing the invention within the scope of the appended claims.

1. A vehicle comprising:
a vehicle body including a wall at least partially defining a passenger compartment;
a first member being mounted with respect to the wall, having a first surface that is generally horizontal, and defining a lower seat portion of a vehicle seat;
a second member having a second surface;
at least one fastening element mounted with respect to the second member;
a first complementary fastening element mounted with respect to the first member and being selectively engageable with said at least one fastening element to operatively connect the second member to the first member such that the second surface is generally horizontal; and
a second complementary fastening element mounted with respect to the wall and being selectively engageable with said at least one fastening element to operatively connect the second member to the wall such that the second surface is generally vertical.

2. The vehicle of claim 1, wherein the vehicle body includes a floor that at least partially defines a footwell forward of the first member; and
wherein the second member extends over at least a portion of the footwell when said at least one fastening element is engaged with the first complementary fastening element.

3. The vehicle of claim 1, wherein said at least one fastening element includes a protrusion, and wherein the first and second complementary fastening elements are concavities.

4. The vehicle of claim 1, wherein the first member is rotatably mounted with respect to the wall.

5. A vehicle comprising:
a vehicle body having a wall that at least partially defines a passenger compartment;
a first member having a first surface and being movably mounted with respect to the wall such that the first member is selectively rotatable between a stowed position in which the first surface is generally vertical and a deployed position in which the first surface is generally horizontal;
a second member having a second surface;
at least one fastening element mounted with respect to the second member;
a first complementary fastening element mounted with respect to the first member; and
a second complementary fastening element mounted with respect to the wall;
wherein said at least one fastening element is selectively engageable with the first complementary fastening element to operatively connect the second member to the first member such that the second surface is generally horizontal when the first member is in the deployed position; and
wherein said at least one fastening element is selectively engageable with the second complementary fastening element to operatively connect the second member to the wall such that the second surface is generally vertical.

6. The vehicle of claim 5, wherein the body includes a floor and structure defining a generally horizontal third surface above the floor; and
wherein the first member is supported by, and contacts, the third surface when the first member is in the deployed position.

7. The vehicle of claim 6, wherein the structure and the floor cooperate to define a footwell; and
wherein the second member is at least partially over the footwell when said at least one fastening element is engaged with the first complementary fastening element.

8. The vehicle of claim 7, further comprising a support member being rotatably mounted with respect to the structure and configured to selectively support the second member when the second member is mounted with respect to the first member.

9. A method of reconfiguring a vehicle seat assembly having a seatback portion and a lower seat portion, the method comprising:
detaching a member that forms at least a portion of the seatback portion from a wall that at least partially defines a passenger compartment; and
attaching the member to the lower seat portion.

10. The method of claim 9, wherein the member includes a surface; and wherein the surface is generally vertical during said detaching, and wherein the surface is generally horizontal during said attaching.

11. The method of claim 10, further comprising rotating the lower seat portion with respect to the wall from a stowed position to a deployed position.
